(19) United States
(12) Patent Application Publication
(10) Pub. No.: US 2008/0281679 A1
(43) Pub. Date: Nov. 13, 2008

(54) COMPETITIVE FULFILLMENT OF DISCRETE OPPORTUNITIES FOR AN IMPRESSION OF BROADBAND VIDEO COMMERCIALS VIA SELF-REGULATING AND SELF-ADAPTIVE DYNAMIC SPOT MARKETS

(75) Inventors: Michael D. Shehan, Longmont, CO (US); J. Allen Dove, Boulder, CO (US); Steven B. Swoboda, Denver, CO (US)

Correspondence Address: MICHAEL A DESANCTIS;HAMILTON DESANCTIS & CHA LLP, FINANCIAL PLAZA AT UNION SQUARE, 225 UNION BOULEVARD, SUITE 305, LAKEWOOD, CO, 80228, US

(73) Assignee: BOOYAH NETWORKS, INC. A Delaware Corporation

(21) Appl. No.: 12/117,726

(22) Filed: May 8, 2008

Related U.S. Application Data
(60) Provisional application No. 60/916,794, filed on May 8, 2007.

(51) Int. Cl. G07G 1/00

(52) U.S. Cl. 705/10

(57) ABSTRACT

Systems, methods and business models for facilitating the syndication of broadband video commercials are provided. According to one embodiment, eligible broadband video commercials from an electronic marketplace are syndicated in real time via competitive fulfillment against an opportunity for an impression and its derived targeting vectors by self-regulating and self-adaptive dynamic spot markets.

### CROSS-REFERENCE TO RELATED APPLICATIONS

This application claims the benefit of U.S. Provisional Application No. 60/916,794 filed on May 8, 2007, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright (©2007-2008 Booyah Networks, Inc.

### BACKGROUND

1. Field

Embodiments of the present invention generally relate to delivery of broadband video content. More specifically, embodiments of the present invention provide for competitive matching and syndication of broadband video commercials to dynamic advertising inventory and comprise a core component of dynamic, real-time spot market-based marketplaces. Within these marketplaces, supply and demand generally set the market price for broadband video commercials on a cost per single impression basis with “bid-for-priority” algorithms. These algorithms further influence broadband video commercial competitive fulfillment by determining a real-time “effective” cost-per- impression (eCPM) based on the monetization tactics and fees an advertiser is will to pay during the syndication of their commercial by a publisher and as biased by a number of factors. These factors may include, but are not limited to, the historical behavior of consumer interactions with the various broadband video commercial creative; the historical monetary yield for the broadband video commercial at issue; the historical monetization of collateral advertising, such as synchronized and/or adjacent banner advertisements; and/or historical success and monetary yield of advertisements against particular inventory origins and the behavioral characteristics of its consumers.

2. Description of Related Art

The Internet has become an increasingly attractive medium for advertisers of information, products and services to reach consumers. The Interactive Advertising Bureau (IAB) reported in April, 2006 that overall internet advertising revenue (U.S.) for 2005 totaled $12.5 billion, a 30% increase over 2004 revenue.

The growth of online video has likewise accelerated. According to a study of more than 1,200 Internet users released by the Online Publishers Association, 24% indicated that they watched online video at least once a week, while 46% said they watched at least once a month. The online video hosting site YouTube.com streams millions of videos per day and attracts an audience of more than 9 million people a month, according to Web measurement firm Nielsen/NetRatings. In 2004, both Yahoo! and Google launched video search engines, and all three major portals—Yahoo!, MSN and AOL—have embarked on aggressive video content strategies.

The features of video, audio and animation that online video offers are attractive to advertisers because these features support objectives such as awareness and message association. Many names have been used to describe the TV-like “video ad” units that have been inserted before, during or after online video, including: in-stream commercials, in-video commercials, streaming commercials, video commercials, multimedia adjacencies, and many others. So as to have a standard term for these ad units, the IAB has recommended using the name “Broadband Video Commercial” to refer to these units. According to market research firm eMarketer, advertising spending in the US on Broadband Video Commercials will nearly triple to $640 million in 2007, from only $225 million in 2005. By 2009, video ad spending is projected to reach $1.5 billion.

The current paradigm for placing Broadband Video Commercials mirrors the traditional process of buying and placing television commercials, a typically complicated, confusing, and time-consuming process that often demands the mediation of an agency as a liaison between advertiser and publisher. Typically, the parties negotiate an explicit contract to sponsor videos with Broadband Video Commercials. This commonly requires signing an agreement and committing to purchase a prescribed volume of inventory at pre-set prices across a pre-determined taxonomy of video offerings.

### SUMMARY

Systems, methods and business models are described for facilitating the syndication of broadband video commercials. According to one embodiment, eligible broadband video commercials from an electronic marketplace are syndicated in real time via competitive fulfillment against an opportunity for an impression and its derived targeting vectors by self-regulating and self-adaptive dynamic spot markets.

In the aforementioned embodiment, the invocation by a publisher origin interface discrete electronic syndication request of the marketplace syndication interface may dynamically create an opportunity for an impression and executes one or more competitive spot markets around targeting vectors that are determined by the marketplace based on characteristics derived explicitly from the syndication request and/or contextually derived from internal marketplace metadata about the syndicating publisher and origin.

In the aforementioned embodiment, the measure of inventory monetization may be defined within the marketplace by chains of impression events as the aggregation of these event occurrences during an opportunity for an impression at a publisher origin electronic interface.

In the aforementioned embodiment, the marketplace impression chains may define the discrete impression events that can occur at a publisher origin electronic interface in response to consumer direct and/or indirect interactions with a syndicated broadband video commercial and its creative and further serve as the measure within the marketplace of the relative yield of a syndicated bid against a discrete opportunity for an impression, which represent the statistical basis of overall domain-leveled yield calculation for a bid within the marketplace.

In the aforementioned embodiment, the marketplace impression chain definitions may describe the relationships between its links (e.g., dependencies, sequences, parallel events, etc.) and their individual weights such that each link electronically processed by the marketplace during the syndication lifecycle adds to the aggregate total weight of an impression chain for a specific opportunity for an impression.

In various instances of the aforementioned embodiments, the syndication lifecycle may include the electronic tracking of discrete impression event occurrences against broadband video commercials syndicated electronically to a publisher origin interface by typical consumer direct and/or indirect interactions with the electronic interface of a publisher origin and for the purpose of allowing the marketplace to predict the ability of a bid and its associated broadband video commercial to monetize similar advertising inventory in the future.

In the context of various of the aforementioned embodiments, competitive fulfillment may be made in aggregate and sequentially ordered by ranked determination of the predicted probability of monetization of an opportunity for an impression from the eligible broadband video commercials bids within the marketplace as placed against one of the derived targeting vectors.

In the aforementioned embodiment, the set of eligible broadband video commercial bids may be associated with broadband video commercial definitions within the marketplace that vary from another in type, structure, creative elements and electronic consumer interaction models and impression events. The set of eligible broadband video commercial bids may also be associated with varying impression monetization tactics (i.e., cost-per-click, cost-per-impression, cost-per-acquisition, etc.) and associated fees to be paid by an advertiser when those tactics are achieved during syndication.

In the context of various of the aforementioned embodiments, competitive fulfillment for a discrete opportunity for an impression in a spot market may be yield-based, wherein bids competing in the spot market each have associated bid yields representing a relative “effective” cost-per-impression (eCPM) value of the bid as dynamically formulated against the bid's expected rate of related impression tactic monetization for the particular spot market.

In the aforementioned embodiment, the eCPM value calculated by the marketplace and associated with each bid is not an absolute fee to be paid by an advertiser during broadband video syndication but rather it is a calculated probability that a particular broadband video commercial bid will be monetized during a discrete opportunity for an impression, event P(A) such that P(A) ⊂ [0,1], where an eCPM of 1 is almost surely to result in monetization of the opportunity and 0 is not necessarily excluded from possible monetization.

In the aforementioned embodiment, the absolute fees to be paid by an advertiser against an opportunity for an impression may be dependent upon the monetization tactics and fees associated with the syndicated bid and are charged by the marketplace only if the impression links tracked during the syndication lifecycle for the impression opportunity are of sufficient weight to trigger one or more monetization tactics of the bid and as defined within the appropriate marketplace impression chain.

In the aforementioned embodiments, the calculations used to determine the eCPM value of a bid may be determined by the marketplace based on one or more of (i) metadata about the bid to include the associated broadband video commercial type and the chain of possible related impression events as defined by the marketplace against that broadband video commercial type; (ii) specifically tracked impression event data about the opportunity for an impression; (iii) the aggregation of impression monetization tactics and their associated fees for a bid as placed against a specific opportunity for an impression (bid-for-priority); and (iv) any or all of the statistical basis historically recorded by the marketplace about the bid and associated broadband video commercial as syndicated against similar opportunities for an impression.

In the aforementioned embodiment, the input to the calculations may include one or more of (i) the various impression chain metadata as defined against particular broadband video commercial types and its links as defined and that can occur during syndication and consumer interaction as impression events, (ii) the total weight and metadata associated with an impression chain as electronically tracked by the marketplace as the sum of the weights of its individually tracked links for a specific syndicated bid against an opportunity for an impression, (iii) the aggregate and individual monetary yield associated an opportunity for an impression by the impression monetization tactics of the bid triggered by impression event tracking during that opportunity and (iv) the historical performance metrics of bids and their broadband video commercials against similarly or dissimilarly specific inventory including but not limited to statistics and measures of overall monetary yield; click-thru-rates (CTR); individual and aggregate creative abandonment rates; average costs-per-acquisition; and temporally-reflective performance and other statistics specific to the broadband video commercial type, impression chains, tracked impression events and specific inventory.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates the high-level lifecycle of a syndication request in accordance with an embodiment of the present invention.

FIG. 2 illustrates the high-level system architecture, which includes electronic syndication and fulfillment of opportunities for an impression of broadband video commercials via competitive spot markets, in accordance with an embodiment of the present invention.

FIG. 3 is conceptual representation of an impression chain for an in-stream broadband video commercial, complete with link weights and chain weights, including the minimum aggregate weight necessary in order for a related opportunity for an impression to be monetized, according to one embodiment of the present invention.

FIG. 4 is a structured XML document that defines an in-stream broadband video commercial impression chain definition as stored and referenced during the impression processing lifecycle in accordance with an embodiment of the present invention.

FIG. 5 shows the relationship between a typical publisher origin electronic interface HTTP-based syndication request and the marketplace-generated syndication response package in accordance with an embodiment of the present invention.

FIG. 6 depicts the electronic display of an overlay broadband video commercial in accordance with an embodiment of the present invention.

### DETAILED DESCRIPTION

Systems and methods are described for facilitating the syndication of broadband video commercials by way of a self-service, competitive spot market for broadband video commercials, dynamically matching and serving broadband video commercials via a platform that unites video advertisers and publishers. Embodiments of the present invention seek to address various shortcomings of traditional broadband video commercial placement by advertisers against publisher inventory while leveraging network technologies to create a dynamic, real-time marketplace of spot markets. The market pricing of these spot markets are set via the algorithmic confluence of supply, demand and monetization tactics and fees as directly and dynamically influenced by the relative performance metrics of the broadband video commercials competed in real-time spot markets against the supply and each other.

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, various embodiments of the present invention may be described with reference to an Internet implementation, it should be understood that all of the interconnections and functionality provided for publisher and advertiser interactions with the marketplace are intended to be made available for and connected to disparate content origins through any number of different network and communications. Consequently, the present invention is equally applicable to various other network and communications mediums, such as video game networks, proprietary online services or networks, such as America Online, and other present and future broadband technologies.

For the sake of illustration, various embodiments of the present invention are described herein in the context of computer programs, physical components, and logical interactions within modem computer networks. Importantly, while these embodiments describe various aspects of the invention in relation to modem computer networks and programs, the methods and apparatus described herein are equally applicable to other systems, devices, and networks as one skilled in the art will appreciate. As such, the illustrated applications of the embodiments of the present invention are not meant to be limiting, but instead exemplary.

### Terminology

Brief definitions of terms, abbreviations, and phrases used throughout this application are given below.

The phrase “abandonment rate” generally refers to the average rate at which consumers abandon viewing of broadband video commercial creative. In one embodiment, the abandonment rate is measured by dividing the average total percentage of broadband video commercial creative viewed by the total number of viewings initiated.

The term “advertiser” generally refers to a person, company, firm, entity or agent that is interested in running an advertisement campaign. For example, in the context of the online marketplace described herein, an advertiser may participate in the marketplace by managing one or more broadband video commercials and bidding for advertising inventory targets.

The phrase “advertising inventory” generally refers to the availability of advertising opportunities within a particular context typically measured in total units of advertising. For example, in a marketplace in which broadband video commercials are competed on a cost per single impression basis responsive to syndication requests by traffic partners, publishers and/or other video content owners, the advertising inventory is the sum aggregation of all “opportunities for an impression” as received via syndication requests. For example, a publisher web site that offers instructional golfing videos may elect to monetize that content with 15 second video ads that play before each requested video is shown. These advertising opportunities appear as inventory within the marketplace.

The term “bid” generally refers to a marketplace bid by an advertiser against an inventory target. The inventory target may be associated with an individual listing and linked to one or more impression tactics by a monetary value that indicates the fee the advertiser is willing to pay against those tactics during syndication.

The phrase “bid for priority” generally refers to algorithms employed with reference to spot market competitive fulfillment as used to determine the relative probability that a particularly competed broadband video commercial bid will monetize a specific opportunity for an impression as compared to the other bids competed against the same inventory target. In one embodiment of the present invention, this relative probability is evaluated based on a number of factors to include, but in no way be limited by, the bid and the multiple monetization tactics, the impression chain defined by the marketplace for the associated type of broadband video commercial, various historical data as tracked and computed by the marketplace against the impression events that occur with respect to the bid during syndication against inventory targets, etc.

The phrase “broadband video commercial” or the abbreviation “BVC” generally refers to TV-like “video ad” units inserted before, during or after online video, including: in-stream commercials, in-video commercials, streaming commercials, video commercials, multimedia adjacencies, and the like, as well as in-page video ad placements.

The term “campaign” generally refers to a marketplace organizational artifact associated with an advertiser and used to group broadband video commercials together for syndication and monetization. Typically a campaign also has associated with it a monetary reserve that is debited against syndicated bids.

The phrase “campaign reserve” or simply “monetary reserve” generally refers to the positive or negative monetary balance associated with a campaign.

The term “channel” generally refers to an organization and categorization of rich media content positioned in the marketplace by a publisher as a source of advertising inventory.

The phrase “competitive fulfillment” generally refers to a probabilistic yield-based comparison and ordering of individual bids within a spot market where yield is defined in terms of an effective cost-per-impression (eCPM).

The terms “connected” or “coupled” and related terms are used in an operational sense and are not necessarily limited to a direct physical connection or coupling. Thus, for example, two devices may be couple directly, or via one or more intermediary media or devices. As another example, devices may be coupled in such a way that information can be passed there between, while not sharing any physical connection on with another. Based on the disclosure provided herein, one of ordinary skill in the art will appreciate a variety of ways in which connection or coupling exists in accordance with the aforementioned definition.

The term “consumer” generally refers to an individual human that generates advertising inventory by way of interactions with inventory origin electronic interfaces.

The phrase “cost-per-acquisition” generally refers to the fee associated with a bid and individual broadband video advertisement for an acquisition impression tactic that an advertiser pays for each consumer acquisition of produces or service directly related to the syndication of the advertisement.

The phrase “cost-per-click” generally refers to the fee associated with a bid and individual broadband video advertisement for a click impression tactic that an advertiser pays for each click impression link generated during syndication.

The phrase “cost-per-impression” generally refers to the fee associated with a bid and individual broadband video advertisement for an impression tactic that an advertiser pays for each valid impression generated during syndication.

The term “coverage” generally refers to the average depth of broadband video commercials competed and available for syndication within a spot market and against an opportunity for an impression.

The term “creative” generally refers to content and/or information associated with broadband video commercials to include videos, rich media banners and text (title, description, etc).

The phrase “click-through-ratio” or the acronym “CTR” generally refers to the ratio of click impressions to total impressions.

The acronym “eCPM” generally refers to a statistic or measurement of the probabilistic ability of a broadband video advertisement to monetize a specific segment or target of advertising inventory.

The term “fee” generally refers to the monetary amount an advertiser pays against an impression tactic.

The phrase “fee weight” generally refers to the “weight” threshold an impression tactic must meet before a fee can be charged to an advertiser during syndication.

The term “fraud” generally refers to any impression activity that is generated at an inventory origin and was not generated by natural and expected consumer interactions or was generated by an entity or automated process with the explicit intention of artificially affecting impression data and performance metrics to included tactic monetization.

The term “fulfillment” generally refers to the dynamic matching and syndication of broadband video commercials against or within a spot market for advertising inventory.

The term “impression” generally refers to one or more events, e.g., a collection, or chain, that correlate directly to an opportunity for an impression against a particular broadband video commercial and one or more interactions a consumer performs against a syndicated broadband video advertisement creative during that opportunity at a channel origin interface.

The phrase “impression event” generally refers to any direct or indirect electronic interaction a consumer may have with a syndicated listing via an electronic publisher origin interface. Examples of possible impression events are, but not limited to, the display of broadband video commercial creative, clicks against broadband video creative, and consumer acquisition of wares at advertiser electronic interfaces associated with broadband video commercials.

The phrase “impression link” generally refers to the definition within the marketplace of a discrete impression event that occurs during the syndication of a broadband video commercial and as is the related and weighted to and against other links within an impression chain definition.

The phrase “impression tactic” generally refers to certain events or aggregation of related events in a particular impression chain that can be identified as monetization tactics requiring a fee be paid by an advertiser when they occur during broadband video commercial syndication against advertising inventory.

The phrase “impression tracking” generally refers to the act of registering individual impression events that occur when a broadband video commercial and/or its creative are syndicated against an opportunity for impression.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

The phrase “inventory origin” generally refers to the source of consumer direct or indirect interaction with a publisher electronic interface.

The phrase “inventory target” generally refers to any individual or set of advertising inventory characteristics as segmented within the marketplace, such as by publisher, channel or tagged content, geography, demographics, keywords, content categories, time of day, date, behavior, etc.

The term “listing” generally refers to a broadband video commercial made available for syndication. An example of a listing is a broadband video commercial made available for syndication by an advertiser in the marketplace whose data elements, including rich media content, are defined by a marketplace listing type.

If the specification states a component or feature “may”, “can”, “could”, or “might” be included or have a characteristic, that particular component or feature is not required to be included or have the characteristic.

The term “marketplace” generally refers to the place or location, actual, virtual or metaphorical, in which spot markets operate. In accordance with embodiments of the present invention, an online virtual marketplace (or meeting point for supply and demand of advertising inventory) is created by way of bringing buyers (advertisers) and sellers (publishers) of advertising inventory together.

The phrase “opportunity for an impression” generally refers to a discrete syndication request by a publisher origin interface where one or more broadband video advertisements are to be presented in response to some activity by a consumer on that origin.

The term “publisher” generally refers to a person, company, firm, entity or agent that owns content or the rights to content and is interested in providing advertising inventory in relation to such content. For example, in the context of the online marketplace described herein, a publisher may participate in the marketplace by providing advertising inventory via syndication requests that result from one or more channel and/or specific rich media content interactions with consumers.

The phrase “publisher origin interface” generally refers any electronic interface provided to a consumer for interaction with publisher media and/or other content. Examples of a publisher origin interfaces are, but not limited to, a Web site, video game play, 3GP mobile applications or interactive television content.

The phrase “reflective futures” generally refers to an ability on the part of the marketplace to predict the relative true “value” of individual bids competed within a spot market. In one embodiment, the true value of individual bids within a spot market is determined by reflecting various historical impression performance and statistical data about the individual competed bids and listings against the current spot market dynamics.

The term “responsive” includes completely or partially responsive.

The term “spot market” generally refers to a market in which commodities are bought and sold for cash and immediate delivery. In accordance with various embodiments, a spot market represents the immediate and dynamic confluence of active open market broadband video commercial bid competition against inventory targets associated with a unique opportunity for an impression offered by a publisher for immediate fulfillment during a syndication request.

The term “syndication” generally refers to the supply of material for reuse and integration with other material. In the context of various of embodiments of the present invention, syndication is the set of impression events and activities that occur against a particular broadband video commercial during a discrete opportunity for an impression to include the inclusion of the broadband video commercial in a response to a publisher syndication request and all rich media creative requests and rendering interactions performed by a channel origin or during tagged content rendering and any direct interactivity a consumer has with the advertisement.

The phrase “syndication action” generally refers to any direct or indirect publisher or consumer action that occurs against a rich media listing during syndication and results directly in an impression link.

The phrase “syndication request” generally refers to an electronic request by a publisher to the marketplace for one or more broadband video commercials to be presented in response to some activity by a consumer on a channel origin or during tagged content rendering.

The phrase “tagged content” generally refers to discrete rich media content positioned in the marketplace by a publisher as a specific source of advertising inventory. Tagged content is usually associated with one or more channels and is rendered directly to a consumer and may included optional advertising “slots” that can be bid upon within the marketplace by advertisers and represent distinct advertising inventory.

The term “weight” generally refers to a collectively calculated value for a particular impression tactic using the impression data recorded during syndication against the impression links that define it for a particular opportunity for an impression.

The term “yield” generally refers to the relative value of a broadband video commercial bid for a particular spot market as dynamically formulated against its expected rate of related impression tactic monetization, possibly preferentially biased, and weighted against the fees offered for those tactics.

### Overview

In accordance with various embodiments of the present invention, spot market competitive fulfillment is performed against discrete opportunities for an impression. An opportunity for an impression is an individual advertising syndication event received by the marketplace from a particular publisher inventory origin (e.g., website, video game, television/interactive programming, etc.). Collectively, these opportunities for an impression represent advertising inventory (supply) to the marketplace.

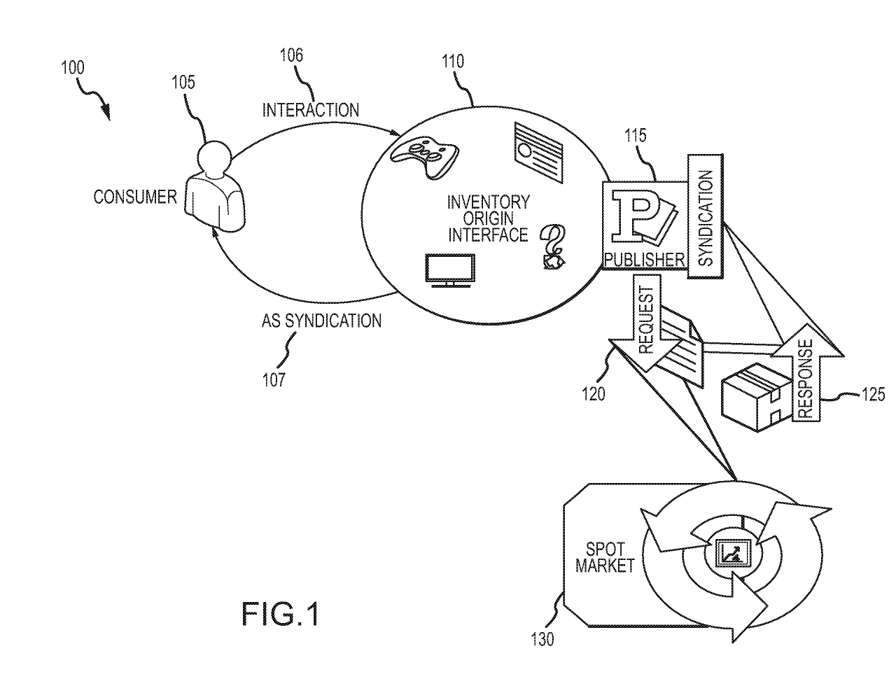

FIG. 1 illustrates the high-level lifecycle 100 of a syndication request 120 in accordance with an embodiment of the present invention. According to the present example, syndication events are triggered by some typical consumer direct and/or indirect interaction 106 with the electronic interface of a publisher origin (publisher origin interface 110). This process is illustrated in FIG. 1. Upon triggering, the publisher origin systems 115 initiate a formal syndication request 120 to the marketplace 130 via an electronic communications medium and data format. As illustrated by FIG. 1, in one embodiment of the present invention this is via, but not limited to, TCP/IP and HTTP.

When received by the marketplace 130, this syndication request 120 is interpreted as a discrete opportunity for an impression and one or more vectors of targeting characteristics are derived explicitly from the syndication request 120 and/or implicitly from metadata contained within the marketplace 130 about the particular syndication origin 115. Typically, derived targeting characteristics include but are not limited to publisher, channel or tagged content, geography, demographics, keywords, content categories, time of day, date, behavior, etc. Spot markets 130 are then dynamically created and competed in aggregate by the marketplace according to the individual vectors of targeting data derived.

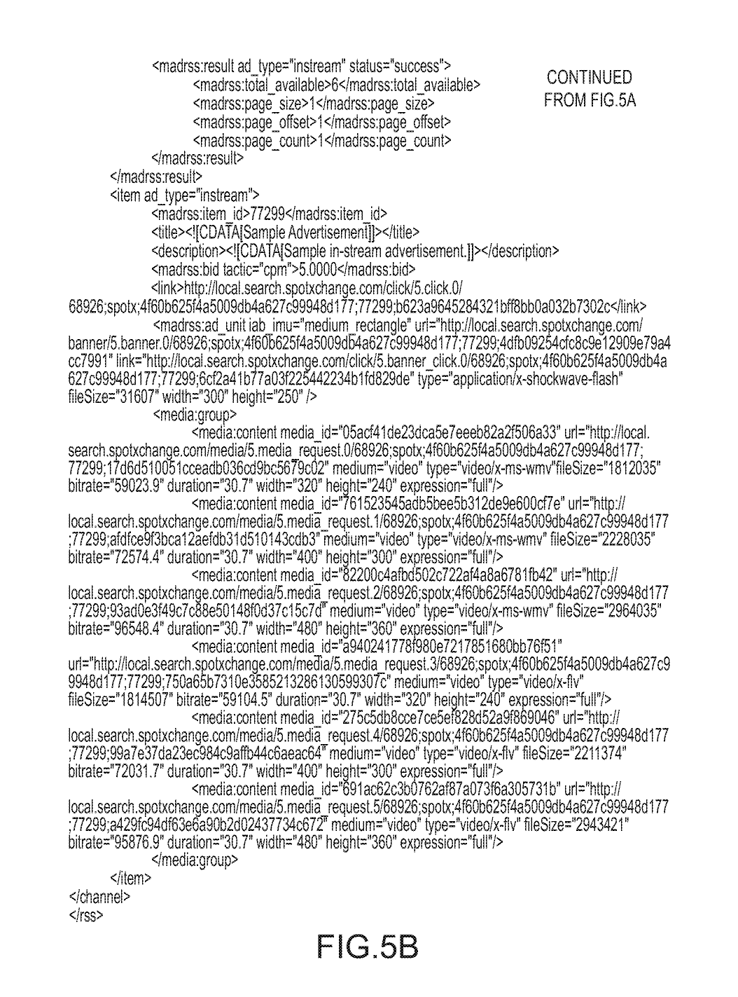

Spot markets 130 form during syndication by matching individual active broadband video commercial bids (bids) to each discrete vector of targeting derived from an opportunity for an impression. These bids are then dynamically competed in real-time based on their “effective” cost-per-impression (eCPM) as tracked and derived by the marketplace, with higher eCPM bids taking priority over lower eCPM bids. Each bid is furthermore uniquely associated in the marketplace with an individual broadband video commercial, or listing. When matched and ordered by a spot market, listing and bid data will be returned in a packaged response 125 to the publisher origin 115 electronically. Referencing again FIG. 1, one embodiment of the present invention utilizes, but is not limited to, TCP/IP and XML, as is shown in FIG. 5.

In one embodiment, the marketplace syndication response package 125 returns listing and bid data, ordered from highest-to-lowest eCPM and in a quantity that is the minimum of the count explicitly defined in the syndication request 120 or the total listings available within the spot markets 130 for the specific opportunity for an impression. Each of the listing and bid data are also syndicated with impression tracking components that will allow the marketplace to uniquely associate and track this particular opportunity for an impression against the bid and listing. At this point, the listing and bid data are said to be syndicated and the process of impression tracking has formally begun.

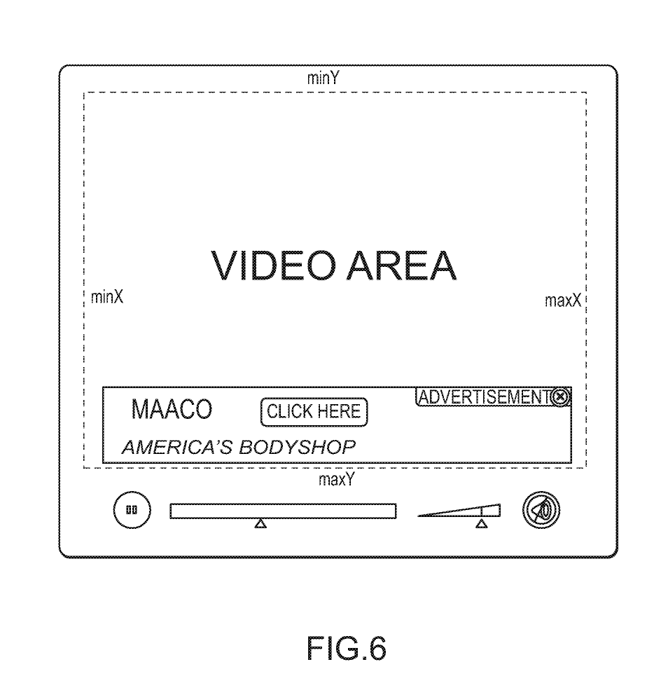

Once received by the publisher origin 115, the origin consumer interface 110 parses and interprets the marketplace response package 125 and displays to the consumer 105 for direct or indirect interactions the syndicated listings in normal course and in a manner appropriate to each listing type and content. In one embodiment of the present invention, this could include, but is not limited to, injecting an in-stream broadband video commercial into an origin-specific media playlist or visually overlaying interactive Adobe Flash or Microsoft Silverlight content onto origin content, the later similarly but not restricted by that depicted in FIG. 6. Furthermore, the publisher origin consumer interface 110 submits to the marketplace for tracking the discrete impression events that occur against each syndicated listing during typical consumer direct or indirect interactions 106 with those listings at the origin interface 110 and in form and fashion as specified by the marketplace 130 in the syndication response package 125 for the interacted bid and listing.

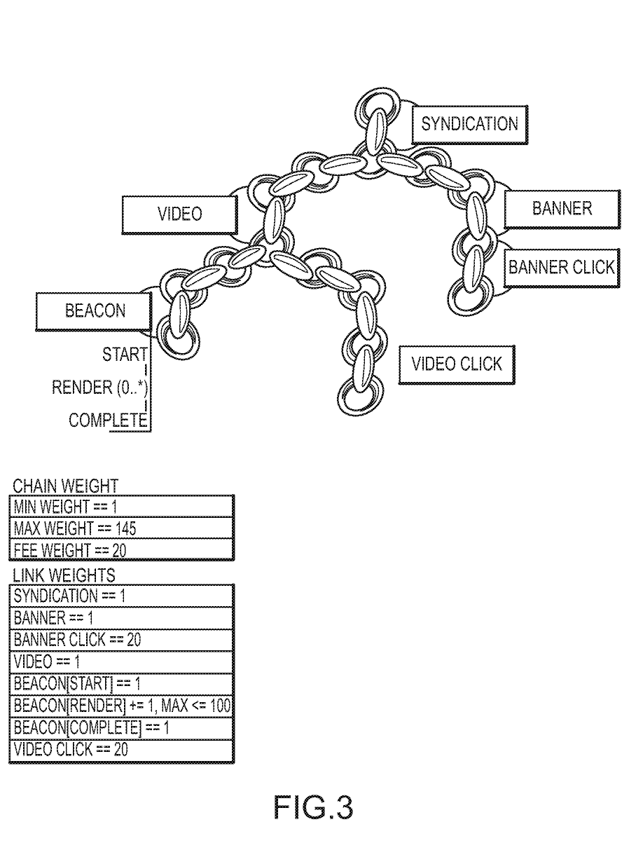

According to one embodiment, tracking of impression event occurrences are handled similarly to that of the initial syndication request where the publisher origin interface 110 initiates the communication to the marketplace 130 via some electronic communications medium and data format. Referencing FIG. 3 with continuing reference to FIG. 5, one embodiment of the present invention utilizes TCP/IP and HTTP requests to track these impression events, with the marketplace recording and processing the data associated with each HTTP request as specific to an individual impression event occurring during a specific opportunity for an impression and associated with a listing and bid as specified in the syndication response package 125. Additionally, the marketplace 130 may return publisher origin interface HTTP or other responses that instruct the publisher origin interface to direct the consumer to an appropriate electronic interface supplied by the advertiser of the syndicated listing, such as another Web site.

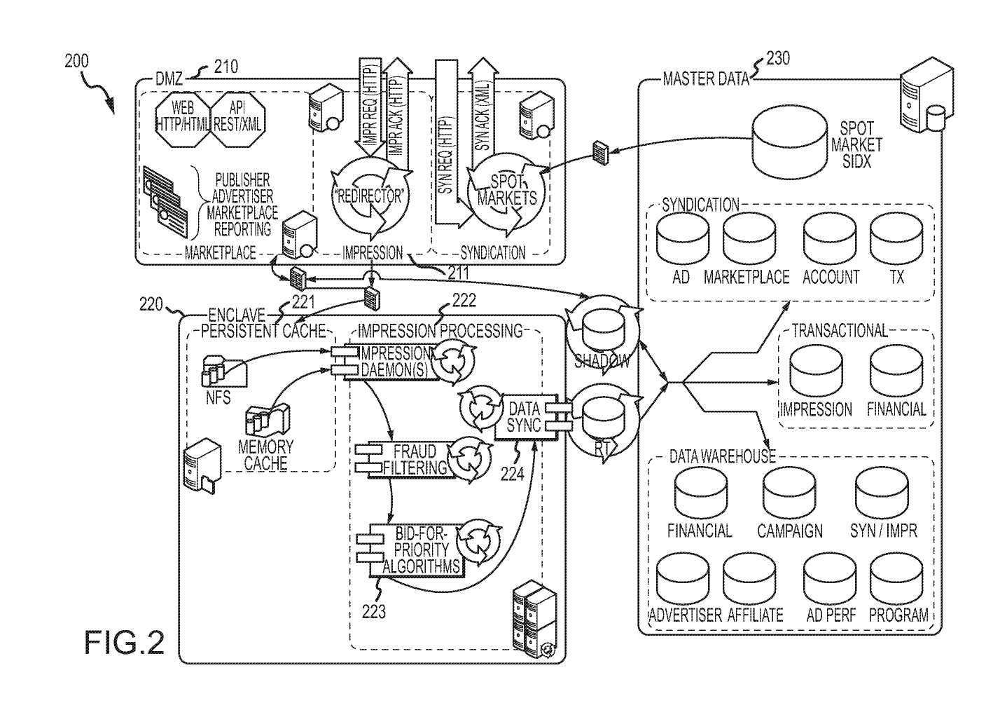

This lifecycle 100 of syndication request to bid and listing impression event tracking forms the mechanisms by which competitive fulfillment of discrete opportunities for impressions of broadband video commercials via self-regulating and self-adaptive dynamic spot markets occur within the marketplace and for which the systems and methods of various embodiments of the present invention support. One embodiment of the present invention is described architecturally in FIG. 2 and is continually referenced herein.

FIG. 2 illustrates the high-level system architecture 200, which includes electronic syndication and fulfillment of opportunities for an impression of broadband video commercials via competitive spot markets, in accordance with an embodiment of the present invention.

The bids competed in each spot market may be associated with

(i) listings that vary in type, structure, creative elements, electronic consumer interaction models and impression tracking from one another; and

(ii) multiple varying impression monetization tactics (i.e., cost-per-click, cost-per-impression, cost-per-acquisition, etc.) and associated fees to be paid by an advertiser when those tactics are achieved during syndication.

The measure of impression tactic monetization is defined within the marketplace by chains of impression events (impression chains) and by the aggregation of these event occurrences during an opportunity for an impression. Impression chains define the discrete impression events (links) that can occur at a publisher origin interface in response to consumer direct or indirect interaction with a syndicated listing type and its creative and serve as the measure within the marketplace of a discrete opportunity for an impression, which represent the statistical basis of eCPM calculation for a bid and its listing within the marketplace.

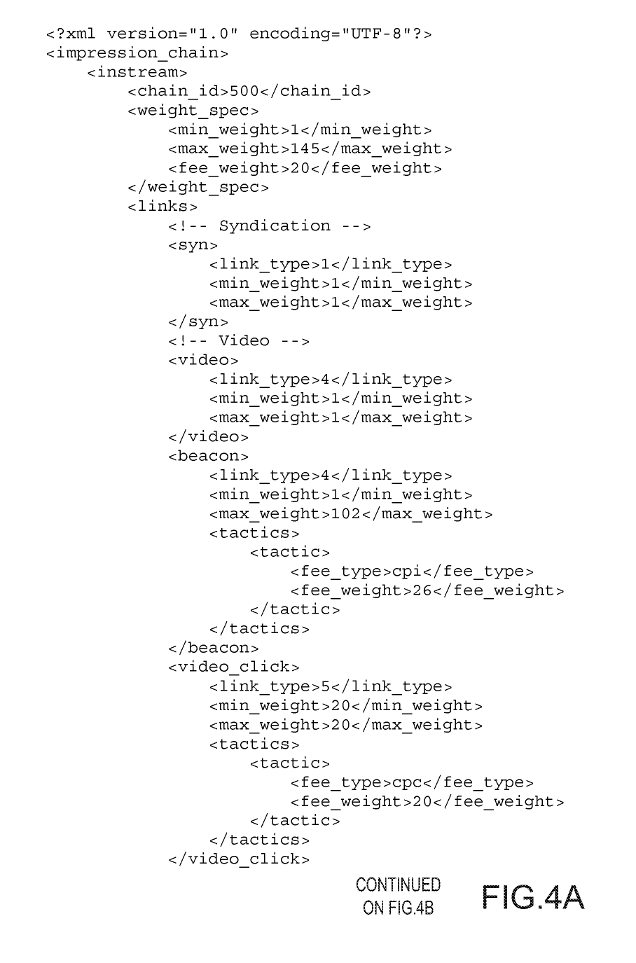

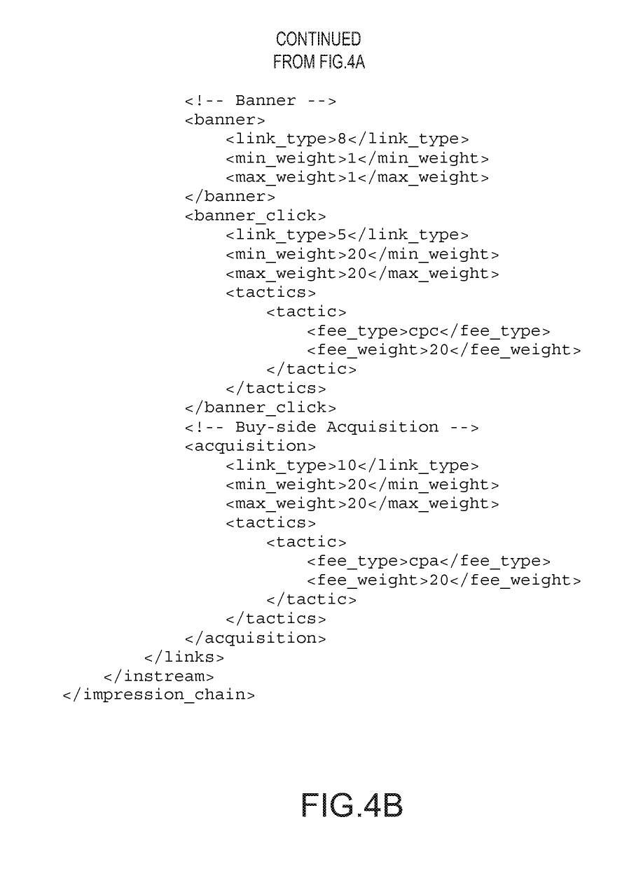

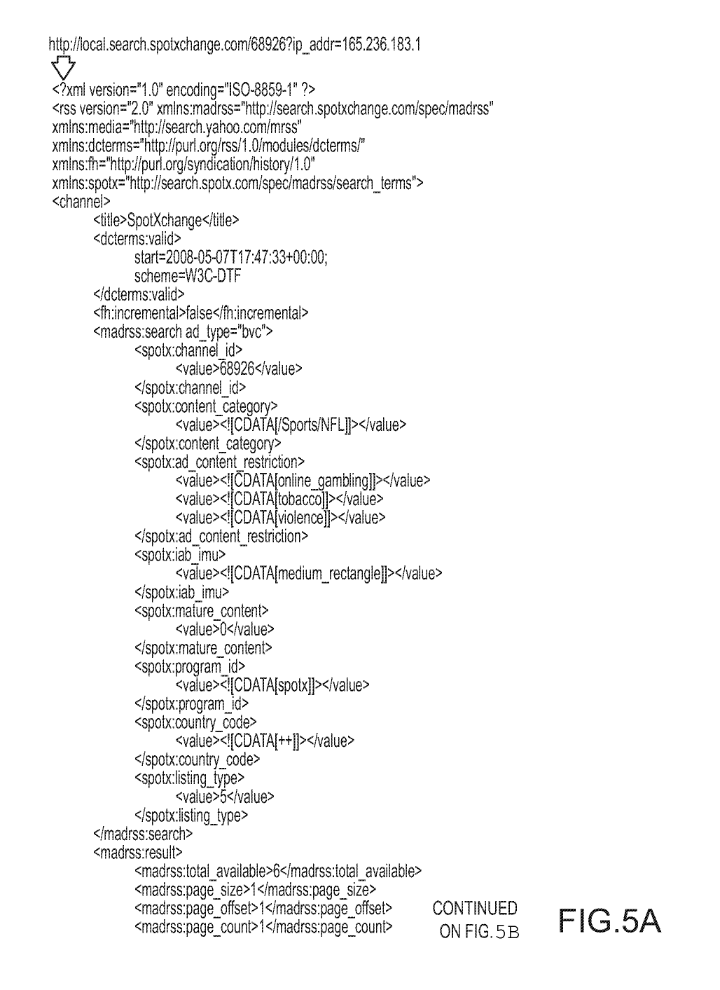

In one embodiment of the present invention, impression chain definitions are stored and processed by the marketplace impression processing via XML documents and in structure similar to FIG. 4. As such, FIG. 4 is a structured XML document that defines an in-stream broadband video commercial impression chain definition as stored and referenced during the impression processing lifecycle in accordance with an embodiment of the present invention.

An impression chain defines the relationships between its links (e.g., dependencies, sequences, parallel events, etc.) and their individual weights. As each link is processed by the marketplace during listing syndication at a publisher origin interface, the total weight of an impression chain for a specific opportunity for an impression (W_{C}^{tracked}) is defined as the aggregation of the weights of each link individually tracked (W_{L}^{tracked}) and processed by the marketplace for that opportunity:

$${W}_{C}^{tracked} = {\sum }_{i = 1}^{N} {W}_{{L}_{i}}^{tracked} ,$$

where N is the total number of impression links tracked within the chain for a specific opportunity for an impression.

Furthermore, these chains define the minimum weight W_{C}^{tracked} required by the marketplace before an opportunity for an impression becomes chargeable (W_{C}^{chargeable}), or, in other words, the weight at which an opportunity for an impression is monetized (fee weight). Therefore, an impression chain is monetized if W_{C}^{chargeable}≦W_{C}^{tracked}.

In one embodiment of the present invention and with continuing reference to FIG. 2, each link in an impression chain for a particular bid and listing syndicated in response to an opportunity for an impression is tracked by the marketplace DMZ Impression component 211 in response to a HTTP request received from the syndicating publisher origin interface. Per the syndication request package, this request represents a specific impression event occurrence derived from a direct or indirect consumer interaction with the syndicated bid and listing for a specific opportunity for an impression. The DMZ Impression component 211 would persistently cache this impression link in the Enclave Persistent Cache subsystem 221 for real-time calculation of the bid eCPM value by the Enclave Impression Processing subsystem 222.

Regardless of specific listing type and impression monetization tactics and fees, spot markets ensure that the ordered, syndicated listings will represent the highest potential monetary yield in descending order of monetization probability based on the targeting derived for an opportunity for an impression. To achieve this, the marketplace employs automatic, real-time and reflective biasing techniques during impression processing against the syndicated marketplace bids, their listings and their tracked impression links. These techniques take into account (i) the various impression chains as defined against particular listing types and that can occur during syndication and consumer interaction, (ii) the aggregation of impression monetization tactics and their associated fees for a bid (bid-for-priority) and (iii) the historical performance metrics of listings against specific inventory including but not limited to overall monetary yield, click-thru-rates (CTR) temporal performance and other statistics specific to the listing type, impression chains, tracked impression events and specific inventory.

The result of this biasing is always defined in terms of an effective cost-per-impression and is associated individually to a specific bid and its targeting within the marketplace as described prior reference. The eCPM value calculated by the marketplace and associated with each bid is not an absolute fee to be paid by an advertiser during listing syndication, rather it is a calculated probability that a particular listing will be monetized during an opportunity for an impression, event P(A) such that P(A) ∈ [0,1], where an eCPM of 1 is almost surely to result in monetization of the opportunity and 0 is not necessarily excluded from possible monetization.

The absolute fees to be paid by the advertiser against an opportunity for an impression is dependent upon the monetization tactics and fees associated with each syndicated bid and is charged by the marketplace only if W_{C}^{chargeable}≦W_{C}^{tracked} for that opportunity for an impression. The fees to be paid by the advertiser are dependent upon the relationship between monetization tactics and the set of W_{L}^{tracked} for the specific opportunity for an impression. As an example, for one embodiment of the present invention and referencing FIG. 4, if a bid for an in-stream listing had monetization tactics “cost-per-click”→T_{CPC}=$0.5000 and “cost-per-impression”→T_{CP1}=$0.0500 for an in-stream listing and was syndicated against an opportunity for an impression, the total fees paid, or monetary yield Y, for that opportunity for an impression could be calculated by the logic pseudo code:

$$\begin{matrix}Y = 0 \\ IF ( {W}_{{Lbanner}_{click}}^{tracked} ∈ {W}_{C}^{tracked} ) OR ( {W}_{{Lvideo}_{click}}^{tracked} ∈ {W}_{C}^{tracked} ) THEN Y += {T}_{CPC} \\ IF ( {W}_{{L}_{beacon}}^{tracked} = {W}_{C}^{tracked} ) AND ( {W}_{{L}_{beacon}}^{tracked} \geq 2 σ ) THEN Y += {T}_{CPI}\end{matrix}$$

As was noted previously, the overall monetary yields of a bid against all opportunities for an impression will factor into its eCPM calculations.

eCPM is chosen as the transform domain for marketplace spot market competitive fulfillment as spot markets are always executed around a single opportunity for an impression and its explicit/implicit targeting vectors and impression processing is always against discrete impression events as syndicated and tracked against an individual opportunity for an impression. These two facts allow for eCPM to be easily calculated during impression processing for a bid and listing as syndicated against individual opportunities for an impression while appropriately reflecting against the historical statistical basis whether that basis be defined against the specific bid and/or the historical aggregation of bids syndicated against the similar inventory.

In one embodiment of the present invention and with continuing reference to FIG. 2, eCPM determination happens within the Enclave Impression Processing subsystem Bid-for-Priority component 223. The algorithms employed by this component are dynamically and individually applied to a bid and its targeting vectors, listing type and monetization tactics as they reflect presently to an opportunity for an impression in terms of monetary yield Y and reflectively against its historical statistical basis for its syndication against similar opportunities for impressions.

Advertising inventory may be highly volatile in terms of its volume, temporal and characteristic distribution. However, the inventory is uniquely segmented by means of targeting vectors derived from syndication requests. These vectors represent the immediate catalyst to form spot markets for competitive fulfillment. However, eCPM calculations require that listing syndication performance be measured and analyzed by means of tracking the various behaviors and attributes of the collective consumer interactive opportunities as compared to the actual monetization of listings against these opportunities. This tracking provides the reflective futures component to bid-for-priority algorithms.

The eCPM transformation allows the marketplace to uniquely exploit its ability to discretely segment advertising inventory into targeting vectors and syndicate in aggregate varied bids against listing types, their impression chains and monetization tactics and fees against these targeting vectors during spot market competitive fulfillment while ensuring that competed bids and their listings are evaluated in real-time against a common domain. The interactive nature of the advertising inventory coupled with these discrete targeting vectors allows for the detailed persistence of historical behaviors by consumers as segmented into individual spot markets. In one embodiment of the present invention and with continuing reference to FIG. 2, these data are persisted in a non-volatile storage by the Enclave Impression Processing subsystem Data Sync component 224 to the Master data stores 230. These data serve to “reflect” into the individual inventory spot markets via the bid-for-priority algorithms as performance metrics and other characteristics of the segmented inventory and serve as the variables to allow the marketplace to determine the true worth of these advertising inventory segments. The realized monetary market value of these futures rises and falls within their spot markets dynamically based on the actual perceived value of the commodity futures by the advertisers competing in associated spot markets. This perception of value within the present invention is dynamic and often times temporal in is regulation.

What is claimed is:

1. A method comprising real-time, syndication of eligible broadband video commercials from an electronic marketplace via competitive fulfillment against an opportunity for an impression and its derived targeting vectors by self-regulating and self-adaptive dynamic spot markets.

2. The method of claim 1, wherein the invocation by a publisher origin interface discrete electronic syndication request of the marketplace syndication interface dynamically creates an opportunity for an impression and executes one or more competitive spot markets around targeting vectors that are determined by the marketplace based on characteristics derived explicitly from a syndication request or contextually derived from internal marketplace metadata about the syndicating publisher and origin.

3. The method of claim 1, wherein the syndication lifecycle includes the electronic tracking of discrete impression event occurrences against broadband video commercials syndicated electronically to a publisher origin interface by one or more of typical consumer direct and indirect interactions with the electronic interface of a publisher origin and for the purpose of allowing the marketplace to predict the ability of a bid and its associated broadband video commercial to monetize similar advertising inventory in the future.

4. The method of claim 2, wherein the measure of inventory monetization is defined within the marketplace by chains of impression events as the aggregation of these event occurrences during an opportunity for an impression at a publisher origin electronic interface.

5. The method of claim 4, wherein marketplace impression chains define the plurality of discrete impression events that can occur at a publisher origin electronic interface in response to one or more of consumer direct and indirect interactions with a syndicated broadband video commercial and its creative and further serve as the measure within the marketplace of the relative yield of a syndicated bid against a discrete opportunity for an impression, the plurality of which represent the statistical basis of overall domain-leveled yield calculation for a bid within the marketplace.

6. The method of claim 5, wherein marketplace impression chain definitions describe the relationships between its links (e.g., dependencies, sequences, parallel events, etc.) and their individual weights such that each link electronically processed by the marketplace during the syndication lifecycle adds to the aggregate total weight of an impression chain for a specific opportunity for an impression.

7. The method of claim 1, wherein said competitive fulfillment is made in aggregate and sequentially ordered by ranked determination of the predicted probability of monetization of an opportunity for an impression from the plurality of eligible broadband video commercials bids within the marketplace as placed against one of the derived targeting vectors.

8. The method of claim 7, wherein the set of eligible broadband video commercial bids may be associated with broadband video commercial definitions within the marketplace that vary from another in type, structure, creative elements and electronic consumer interaction models and impression events.

9. The method of claim 7, wherein the set of eligible broadband video commercial bids may be associated with a plurality of varying impression monetization tactics (i.e., cost-per-click, cost-per-impression, cost-per-acquisition, etc.) and associated fees to be paid by an advertiser when those tactics are achieved during syndication.

10. The method of claim 1, wherein competitive fulfillment for a discrete opportunity for an impression in a spot market is yield-based, wherein bids competing in the spot market each have associated bid yields representing a relative “effective” cost-per-impression (eCPM) value of the bid as dynamically formulated against the bid's expected rate of related impression tactic monetization for the particular spot market.

11. The method of claim 10, wherein the eCPM value calculated by the marketplace and associated with each bid is not an absolute fee to be paid by an advertiser during broadband video syndication but rather it is a calculated probability that a particular broadband video commercial bid will be monetized during a discrete opportunity for an impression, event P(A) such that P(A) ∈ [0,1], where an eCPM of 1 is almost surely to result in monetization of the opportunity and 0 is not necessarily excluded from possible monetization.

12. The method of claim 11, wherein the absolute fees to be paid by an advertiser against an opportunity for an impression is dependent upon the monetization tactics and fees associated with the syndicated bid and are charged by the marketplace only if the impression links tracked during the syndication lifecycle for the impression opportunity are of sufficient weight to trigger one or more monetization tactics of the bid as defined within the appropriate marketplace impression chain.

13. The method of claim 11, wherein the calculations used to determine the eCPM value of a bid are determined by the marketplace based on one or more of (i) metadata about the bid to include the associated broadband video commercial type and the chain of possible related impression events as defined by the marketplace against that broadband video commercial type; (ii) specifically tracked impression event data about the opportunity for an impression; (iii) the aggregation of impression monetization tactics and their associated fees for a bid as placed against a specific opportunity for an impression (bid-for-priority); and (iv) any or all of the statistical basis historically recorded by the marketplace about the bid and associated broadband video commercial as syndicated against similar opportunities for an impression.

14. The method of claim 12, wherein the input to the calculations include one or more of (i) the various impression chain metadata as defined against particular broadband video commercial types and its links as defined and that can occur during syndication and consumer interaction as impression events, (ii) the total weight and metadata associated with an impression chain as electronically tracked by the marketplace as the sum of the weights of its individually tracked links for a specific syndicated bid against an opportunity for an impression, (iii) the aggregate and individual monetary yield associated an opportunity for an impression by the plurality of impression monetization tactics of the bid triggered by impression event tracking during that opportunity and (iv) the historical performance metrics of bids and their broadband video commercials against similarly or dissimilarly specific inventory including but not limited to statistics and measures of overall monetary yield; click-thru-rates (CTR); individual and aggregate creative abandonment rates; average costs-per-acquisition; and temporally-reflective performance and other statistics specific to the broadband video commercial type, impression chains, tracked impression events and specific inventory.

15. A method comprising
maintaining publisher accounts for a plurality of publishers and facilitating participation by the plurality of publishers in an auction-based marketplace among the plurality of publishers and a plurality of advertisers, including
providing publisher self-service tools configured to facilitate (i) organization of publisher content into discrete channels and sub-channels, (ii) quantification of volume of available advertising slots and user traffic volume associated with the publisher content, (iii) categorization of the publisher content by geography and traffic demographics, and (iv) enforcement of advertising restrictions or parameters in relation to the publisher content;
providing an ad calling interface through which the plurality of publishers, responsive to a request by a consumer to view the publisher content, call for a set of one or more broadband video commercials in real-time to be run with the requested publisher content.
maintaining a plurality of advertiser accounts for a plurality of advertisers and facilitating participation by the plurality of advertisers in the auction-based marketplace, including providing advertiser self-service tools configured to facilitate (i) loading of broadband video commercials, (ii) targeting of the available advertising slots by geography, demographics, time of day and channel or sub-channel, and (iii) submitting bids for desired available advertising slots; and
auctioning off the available advertising slots by, responsive to an invocation of the ad calling interface by a publisher of the plurality of publishers in relation to a particular piece of content, performing a real-time determination among eligible broadband video commercials regarding broadband video commercial placement for advertising slots associated with the particular piece of content.

16. The method of claim 15, wherein said performing a real-time determination among eligible broadband video commercials regarding broadband video commercial placement for advertising slots associated with the particular piece of content further comprises determining the eligible broadband video commercials by:
filtering out broadband video commercials for which an associated impression quota has been met;
filtering out broadband video commercials that are inactive during a timeframe encompassing a time corresponding with the invocation of the ad calling interface; and
filtering out broadband video commercials that violate the advertising restrictions or parameters associated with the particular piece of content.

17. The method of claim 16, wherein said performing a real-time determination among eligible broadband video commercials regarding broadband video commercial placement for advertising slots associated with the particular piece of content further comprises prioritizing the eligible broadband video commercials based on predicted monetary value to the publisher taking into consideration all current monetary bids by the plurality of advertisers for the advertising slots and one or more of (i) historical behavior of consumer interactions with the eligible broadband video commercials, (ii) historical yields of the eligible broadband video commercials, (iii) historical monetization of collateral advertising paired with the eligible broadband video commercials and (iv) historical success or monetary yield of advertisers represented within the eligible broadband video commercials.

18. The method of claim 17, wherein only active bids against the available advertising slots that match an individual opportunity for an impression and whose related advertising campaigns contain a positive monetary reserve are used to create a spot market.

19. The method of claim 15, wherein the publisher content comprises streaming video.

20. The method of claim 15, wherein the invocation of the ad calling interface dynamically creates and executes a spot market against an inventory of broadband video commercials in the auction-based marketplace meeting characteristics explicitly and implicitly determined by the advertising restrictions or the parameters associated with the requested publisher content.

21. The method of claim 17, wherein only those of the plurality of publishers that are active and approved by a marketplace regulator are capable of generating advertising inventory to be offered for fulfillment by the spot market.

22. The method of claim 15, wherein only those of the discrete channels and sub-channels that are active and approved by a market place regulator are capable of generating advertising inventory to be offered for fulfillment by the spot market.

23. The method of claim 15, wherein competitive fulfillment for a discrete opportunity for an impression in the spot market is yield-based, wherein bids competing in the spot market each have associated bid yields representing a relative value of the bid as dynamically formulated against the bid's expected rate of related impression tactic monetization.

24. The method of claim 17, wherein the associated bid yields are preferentially biased based on fees offered for the related impression tactic.

25. The method of claim 17, wherein the associated bid yields are weighted against fees offered for the related impression tactic.

26. The method of claim 17, wherein the bids competing in the spot market are ranked based on projected value to the publisher as determined by the associated bid yields.

27. A method comprising
maintaining publisher accounts for a plurality of publishers and facilitating participation by the plurality of publishers in a spot market-based marketplace among the plurality of publishers and a plurality of advertisers, including
providing publisher self-service tools configured to facilitate (i) organization of publisher content into discrete channels and sub-channels, (ii) quantification of opportunities for an impression and user traffic volume associated with the publisher content, (iii) categorization of the publisher content by geography and traffic demographics, and (iv) enforcement of advertising restrictions or parameters in relation to the publisher content;
providing an interface through which the plurality of publishers, responsive to a request by a consumer to view the publisher content, make syndication requests for a set of one or more broadband video commercials in real-time to be run with the requested publisher content.
maintaining a plurality of advertiser accounts for a plurality of advertisers and facilitating participation by the plurality of advertisers in the spot market-based marketplace, including providing advertiser self-service tools configured to facilitate (i) loading of broadband video commercials, (ii) targeting of available advertising inventory, represented by an aggregation of all opportunities for an impression available in the spot market-based marketplace, by geography, demographics, time of day and channel or sub-channel, and (iii) submitting bids against desired available advertising inventory; and
fulfilling syndication requests by the plurality of publishers in relation to the publisher content by, responsive to each of the syndication requests,
dynamically creating a spot market comprising an inventory of an aggregate of all active broadband video commercials loaded by the plurality of advertisers meeting the advertising restrictions or the parameters associated with the requested publisher content, and
returning sufficient broadband video commercials from the spot market to satisfy a number of advertising slots associated with the requested publisher content by performing a real-time bid for priority selection process against the spot market.
